(19) United States
(12) Patent Application Publication
(10) Pub. No.: US 2007/0258407 A1
(43) Pub. Date: Nov. 8, 2007

(54) Handover optimization in a wireless network

(76) Inventors: Zexian Li, Espoo (FI); Roman Pichna, Espoo (FI)

Correspondence Address: BRAKE HUGHES BELLERMANN LLP, c/o INTELLEVATE, P.O. BOX 52050, MINNEAPOLIS, MN, 55402, US

(21) Appl. No.: 11/429,402

(22) Filed: May 5, 2006

(51) Int. Cl. H04Q 7/00

(52) U.S. Cl. 370/331

(57) ABSTRACT

Various embodiments are disclosed relating to the optimization of handovers and ranging in a wireless network. According to an example embodiment, an information request may be received, which may include a handover information request, such as a ranging request for handover. Resources for handover information requests may be allocated or applied at a higher priority level than at least some non-handover information requests. Further, a mobile station may perform ranging with a base station, wherein a first value of a retransmission timer at the mobile station is used for non-handover ranging, and a second value of the retransmission timer that is less than the first value is used for handover ranging. Further, a ranging request message including a ranging purpose indication indicating a ranging purpose may be received. Resources for processing the ranging request message may be allocated at a priority level based on the ranging purpose indication.

### BACKGROUND

As wireless technology has advanced, a variety of wireless networks have been installed, such as cellular and other wireless networks. Some wireless networks are based upon the Institute of Electrical and Electronics Engineers (IEEE) 802.11 family of Wireless LAN (WLAN) industry specifications, for example. Other wireless technologies are being developed, such as IEEE 802.16 or WiMax industry specifications. IEEE 802.16 defines the Wireless MAN air interface specification for wireless metropolitan area networks. A number of working groups are working to improve on this technology.

A basic function that many wireless networks perform is mobility of a mobile station from a first base station or access point to a second base station. The mobility in active mode is typically called handover and the mobility in idle mode is typically called location update. For handover, in some networks, a base station may be configured to scan signals, such as signals relating to mobile stations, and other base stations such as neighboring base stations. In some cases, when certain signal conditions are met, a handover may be requested to handover the mobile station from the current base station to a target base station, e.g., based on a higher channel quality at the target base station. For location update, a base station broadcasts its location identifier or location group identifier. A mobile station may receive the location group identifier. If it finds the same location group identifier, does nothing. Otherwise, it may begin a signaling procedure to register in the new location. However, as wireless networks become more complex, the handover process and/or the location update may become more challenging.

### SUMMARY

Various embodiments are disclosed relating to handover and ranging optimization in a wireless network.

According to an example embodiment, an information request may be received. It may be determined that the information request includes a handover information request. Resources are allocated at a higher priority level than a priority level used for information requests other than handover information requests. For example, resources may be allocated or applied to handover information requests at a higher priority level than for at least some non-handover information requests. In an example embodiment, the receiving the information request may include receiving a ranging request message, wherein a value included in a ranging purpose indication indicates a ranging request message for handover. In an example embodiment, the receiving the information request may include receiving a ranging request message, wherein a field included in a header of the information request indicates a handover ranging request message.

In another example embodiment, an apparatus may be provided in a mobile station for wireless communication. The apparatus may include a controller, a memory coupled to the controller, and a wireless transceiver coupled to the controller. The apparatus may perform ranging with a base station to adapt one or more parameters between the mobile station and the base station, wherein a first value of a retransmission timer at the mobile station is used for non-handover ranging, and a second value of the retransmission timer that is less than the first value is used for handover ranging. In an example embodiment, the second value of the retransmission timer is generated based on a time for transmission and a time of processing a message at the base station. In another embodiment, the second value of the retransmission timer indicates a waiting time for determining a lack of receipt of a ranging response message from the base station before retransmitting a ranging request message indicating handover to the base station.

In a further example embodiment, a ranging request message including a ranging purpose indication indicating a ranging purpose may be received. Resources for processing the ranging request message may be allocated at a priority level based on the ranging purpose indication. In an example embodiment, the ranging purpose indication indicates a handover. In an example embodiment, the ranging purpose indication indicates an emergency call or call from emergency personnel or any call from a high priority user terminal, for example.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating a wireless network according to an example embodiment.

FIG. 2 is a diagram of an example wireless network according to an embodiment.

FIG. 3 is a diagram illustrating operation of transmission of information requests for a mobile station according to an example embodiment.

FIG. 4 is a flow chart illustrating operation of handover of a mobile station according to another example embodiment.

FIG. 5 is a flow chart illustrating operation of a retransmission timer of a mobile station according to an example embodiment.

FIG. 6 is a flow chart illustrating operation of ranging requests for a base station according to an example embodiment.

FIG. 7 is a block diagram illustrating an apparatus that may be provided in a wireless station according to an example embodiment.

### DETAILED DESCRIPTION

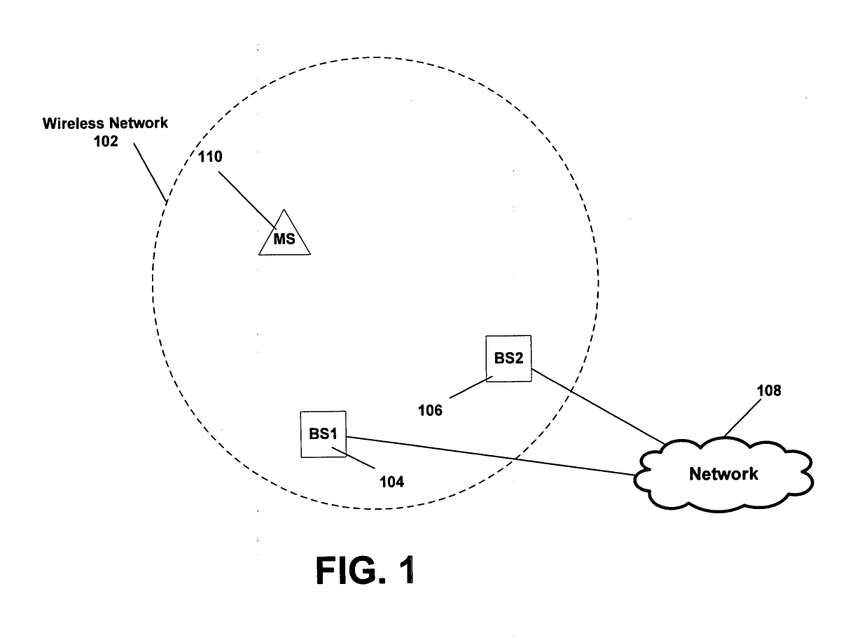

Referring to the Figures in which like numerals indicate like elements, FIG. 1 is a block diagram illustrating a wireless network 102 according to an example embodiment. Wireless network 102 may include a number of wireless nodes or stations, such as base stations BS1 104 and BS2 106, and one or more mobile stations, such as MS 10. While only two base stations and one mobile station are shown in wireless network 102, any number of base stations and mobile stations may be provided. Each base station 104, 106 may be coupled to a fixed network 108, such as a Wide Area Network (WAN), the Internet, etc., and may also be coupled to other wireless networks. The mobile station MS 10 may communicate with the base station 104 or 106.

According to an example embodiment, the mobile station MS 110 may initially be associated with base station BS1 104, for example. In an example embodiment, mobile station MS 110 may travel or move with respect to base station BS1 104. Thus, at some point, the mobile station MS 110 may move out of range of the currently associated base station, BS1 104, and may thus need to be handed over to one or more new base stations, e.g., BS2 106, as mobile station MS 110 travels.

The various embodiments described herein may be applicable to a wide variety of networks and technologies, such as WLAN networks, 802.11 networks, WiMAX networks, IEEE 802.16 type networks, cellular networks, radio networks, or other wireless networks.

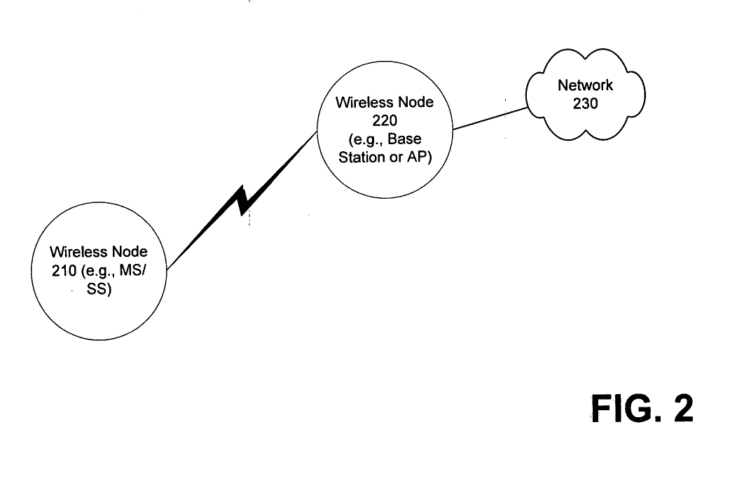

FIG. 2 is a diagram of a wireless network environment according to an example embodiment. A wireless node 210, which may include a mobile station or subscriber station (MS/SS) may be coupled via a wireless link to a wireless node 220. As an example, the wireless node 210 may include a mobile telephone, a wireless personal digital assistant (PDA), or other type of wireless access device, or mobile station. The term “node” may refer, for example, to a wireless station, e.g., a subscriber station or mobile station, an access point or base station, a relay station or other intermediate wireless node, or other wireless computing device, as examples. Wireless node 220 may be, for example, a base station (BS), access point (AP) or other wireless node. Wireless node 220 may be coupled to a fixed network, such as network 230 for example. Frames or data flowing from node 210 to node 220 may be referred to as the uplink (UL) or upstream direction, whereas frames flowing from node 220 to node 210 may be referred to as the downlink (DL) or downstream direction, for example.

In an example embodiment, if the node 210, e.g., mobile station, 210 is moving from one location to another location, the node 210 may experience, for example, a low signal-to-noise ratio in its communications with the node 220, and thus it may become desirable to request a handover, or handoff, of the node 210 from the node or base station 220 to another base station or access point that currently provides a higher signal-to-noise ratio in its communications with the node 210. As another example, the node 210 or node 220 may receive measurement reports, or receive a signal to noise (S/N) ratio, a received signal strength, bit error rate, packet error rate, or other channel quality parameter that may indicate a quality of a signal between the node 210 and the respective node 220, or base station, and may determine that a handover should be requested, based on the received information or other resource usage optimization reasons such as load on different radio channels or transport network.

As part of a handover process, a handover request may be submitted to a target base station, and a decision may be made to handover a mobile station to the target or base station. In some cases, a handover may be delayed due to a mobile station acquiring one or more adjustment parameters from the target base station. For example, a mobile station may transmit an information request message, such as a ranging request message, to a target base station, in order to obtain various adjustment parameters, such as parameters for timing, frequency and power. This exchange of ranging request and ranging response messages may, for example, be referred to as ranging, and may introduce significant delay for the handover process. Such a ranging delay or ranging latency may cause a break in the audible reception and transmission of the node 210. This is because, in some cases, stations do not typically process or handle ranging request messages for handover any differently than ranging request messages for other purposes, such as network entry.

Thus, according to an example embodiment, an information request, such as a ranging request message indicating that the request is for handover, may be transmitted from node 210 (mobile station) to node 220, to request adjustment parameters from node 220 or a target base station. Because the information request or ranging request message indicates that the request is for handover, the processing of the information request or ranging request message for handover may receive a higher processing priority and higher priority of resource allocation than non-handover request messages. In an example embodiment, an information request for handover may be referred to as a handover information request, and, in an example embodiment, a ranging request message that is for handover may be referred to as a handover ranging request, for example.

According to an example embodiment, there may be several high priority ranging purposes. In an example embodiment, a ranging request message may include a ranging purpose indication indicating a ranging purpose, such as a purpose of a ranging request for handover, ranging request for location update, and ranging request for emergency call setup (e.g., emergency call, or call from a high priority user terminal, which may be a call from a emergency team member terminal), or other high-priority request so that the ranging request message may receive a higher processing priority and higher priority of resource allocation than other request messages. Table 1 illustrates a format of a ranging purpose indication field that may be included in a ranging request message, in order to identify a purpose for a ranging request message.

TABLE 1

| Bit value in | |
|---|---|
| Ranging Purpose | |
| Indication (RPI) | |
| Field of Ranging | |
| Request Message | Ranging Purpose |
| Bit 0 | Ranging Request for Handover - when this bit |
| | is set to 1 in combination with other included |
| | information elements, this indicates the MS |
| | is currently attempting to HO or Network |
| | Re-entry to the BS |
| Bit 1 | Ranging Request for Location Update request - |
| | when this bit is set to 1, it indicates a |
| | ranging request for a MS action of Idle Mode |
| | Location update process |
| Bit 2 | Ranging Request for Emergency call setup - |
| | when this bit is set to 1, it indicates a |
| | ranging request for a MS action of emergency |
| | call setup (e.g., handover for emergency call, |
| | or call from high priority user terminal) |
| Bits 3-7 | Reserved |

In response to the information request message or ranging request message, the base station or node 220 may typically respond by transmitting an information response message or ranging response message to provide the adjustment parameters. A mobile station may typically maintain a retransmission timer, where if a response is not received before the timer expires, the mobile station or node 210 may retransmit the information request message or ranging request message. However, additional latency may be introduced during the handover process if an unacceptably longer retransmission timer value is used for handover. For example, if a retransmission timer at the node or mobile station is set, for example, to a default value of 200 ms for all ranging requests, and a real-time application of the node 210 requires a handover data transmission disruption time of less than 50 ms, the node 210 may wait an unacceptably long time to determine that a ranging request for handover needs to be retransmitted to node 220. Thus, according to an example embodiment, a handover retransmission timer at the node or mobile station 210 may be set to a value for triggering a retransmission of the information request message or ranging request message that may be less than a value for the retransmission timer for non-handover ranging requests or information requests. For example, a retransmission timer value of 15 or 20 ms may be used for handover ranging, while a retransmission timer value of 200 ms may be used for non-handover ranging, for example. These are merely example timer values, and other values may be used.

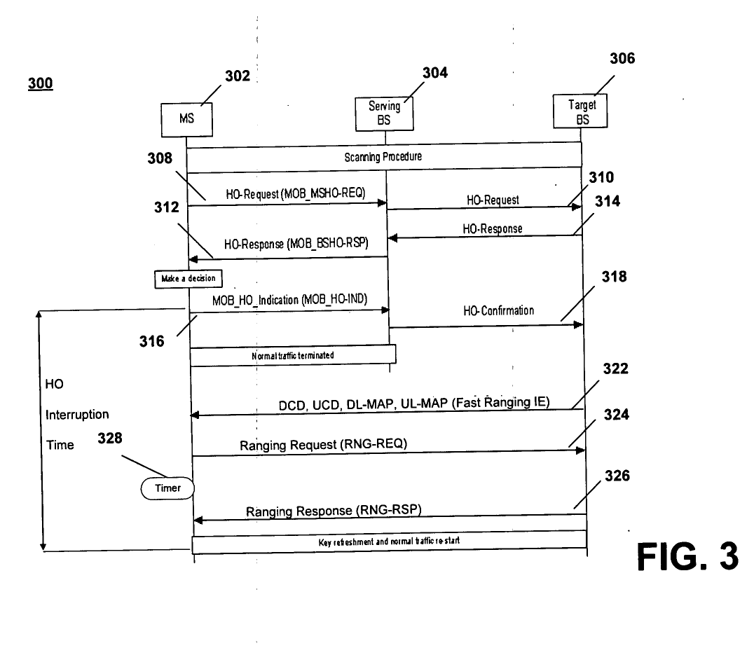

FIG. 3 is a diagram 300 illustrating operation of transmission of information requests for a mobile station according to an example embodiment. In the example shown in FIG. 3, a mobile station 302 may be in communication with a first, or serving base station (serving BS) 304 and a second, or target base station (target BS) 306. Initially, mobile station 302 is associated only with serving base station 304.

As shown in FIG. 3, the mobile station 302, the serving base station 304, and the target base station 306 may all perform a scanning procedure to obtain information relating to signaling among the mobile station 302, the serving base station 304, the target base station 306 and other network nodes. For example, the information may include signal strength information and signal-to-noise ratio information.

A message, e.g., a mobile station handover request message (MOB_MSHO-REQ) 308 may be sent from the mobile station 302 to the serving base station 304. The mobile station handover request message 308 may include an identifier identifying the mobile station 302 to be handed over to the target base station 306. The identifier may be any type of identifier, such as a MS (mobile station) identifier identifying the mobile station, or a connection identifier (CID) (or connection identifiers, (CIDs) for the mobile station 302. The identifier, e.g., CID, for the mobile station 302 may be associated with, or used for communication with, the serving base station 304. In other words, there may be one or more specific CIDs assigned by a base station to each mobile station that is associated with the base station, for example. The identifiers may be, for example, connection identifiers (CIDs) as used for media access control (MAC) communications with mobile stations in accordance with IEEE 802.16, 802.11 or other wireless specification or technology. The mobile station handover request message (MOB_MSHO-REQ) 308 may be optional, as the serving base station 304 may itself initiate the handover.

A determination may be made to initiate a handover of the mobile station 302 from the serving base station 304 to the target base station 306 based on, for example, received channel quality information, such as signal to noise ratios, received signal strength, or other channel quality parameters, or received measurement reports e.g., obtained from scanning signals, for example, among the mobile station 302, the serving base station 304, and the target base station 306 or other neighboring base stations. The measurement reports may include information such as signal to noise ratios or other information relating to signal quality among the mobile station 302, the serving base station 304, and the target base station 306. The scanning may be performed by, for example, the mobile station 302, and the serving base station 304 may trigger the handover request by sending (not shown) a trigger message to the mobile station 302 to initiate the handover of the mobile station 302.

Such a determination to initiate a handover of the mobile station 302 may, for example, occur as a result of the mobile station 302 moving out of range of the serving base station 304, and into the range of the target base station 306. The serving base station 304 or the mobile station 302 may analyze measurement reports of signal data for several other base stations such as base stations neighboring the serving base station 304, and may determine, based on the measurement reports, that a handover should be requested, and that the target base station 306 may be an optimal candidate to become the new, or target base station for the communications with the mobile station 302. Thus, the determination to request handover made by the serving base station 304 or the mobile station 302 may be based on measurement reports generated by the serving base station 304 or received from other sources, or on a received signal to noise (S/N) ratio, received signal strength, or any other channel quality parameter that may indicate a quality of a signal between the mobile station 302 and the respective base station.

Further, the serving base station 304 may determine that a group of other base stations, including the target base station 306, may be good candidates to receive the handover of the mobile station 302, and the serving base station 304 may determine that the target base station 306 is an appropriate choice for the handover, based on, e.g., availability of the target base station 306.

After the mobile station handover request message 308 is sent to the serving base station 304, or a decision is otherwise made at serving base station 304 to perform a handover of the mobile station 302, the serving base station 304 may then send a handover request message 310 to the target base station 306. The handover request message 310 may serve as a request for the target base station 306 to reserve resources and accept handover of the mobile station 302 from the serving base station 304 to the target base station 306.

If the target base station 306 accepts the request and reserves the resources to accommodate the handover, the target base station 306 may send a handover response message 314 to the serving base station 304 as an acceptance of the request to handover the mobile station 302. The serving base station 304 may then send a mobile base station handover response (MOB_BSHO-RSP) message 312, which includes the identifiers associating the mobile station 302 with the serving base station 304, to the mobile station 302. The mobile station 302 may respond by sending a mobile station handover indication (MOB_HO-IND) message 316 to the serving base station 304 to indicate confirmation by the mobile station 302 of the handover. The serving base station 304 may then send a handover confirmation message 318 to the target base station 306 informing the target base station 306 that the mobile station 302 has acknowledged the handover. After sending the mobile station handover indication message 316 to the serving base station 304, the mobile station 302 may detach from the serving base station 304 and start network re-entry with the target base station 306.

The target base station 306 may send a synchronization message 322 that may include downlink and uplink transmission parameters such as a carrier frequency for the target base station 306, a downlink channel descriptor (DCD), an uplink channel descriptor (UCD), and a downlink map (DL-MAP), to the mobile station 302. After synchronization with the target base station 306, the mobile station 302 may receive an uplink map (UL-MAP) which includes information indicating a transmission interval for the mobile station 302. If the target base station 306 has previously received a handover notification from the serving base station 304, e.g., via the backbone, then the target base station 306 may allocate a non-contention-based initial ranging opportunity to the mobile station 302. However, if contention-based ranging is employed, there may exist contention latency in performing ranging between the mobile station 302 and serving base station 304, which may lead to unacceptable data transmission disruption time.

The mobile station 302 and the target base station 306 may then perform handover ranging in order to provide the mobile station 302 with adjustment parameters for timing, frequency, and power from the target base station 306. Thus, the mobile station 302 may send a ranging request (RNG-REQ) message 324 for handover to the target base station 306. According to one aspect, the ranging request message 324 for handover may include an information request wherein a header of the information request indicates a handover ranging request message so that the target base station 306 may recognize the purpose of the ranging request, for handover ranging, without decoding to process the complete information request. Thus, the target base station 306 may provide a high processing priority to the information request message to reduce total processing time for the ranging request message 324 that indicates a handover. Thus, a processing priority and the priority of the resource allocation at the target base station 306 for the mobile station 302 may be based on receipt and identification by the target base station 306 of the ranging request message 324. Similarly, resources may be prioritized at a serving base station for handover ranging.

According to another aspect, the ranging request message 324 for handover may include a ranging code or a ranging purpose indication (RPI) field received by the target base station 306, e.g., after decoding of the received ranging request message 324. For example, a predefined bit included in the ranging purpose indication may be set to indicate a ranging request for handover, such that the setting of the bit in combination with other information elements included in the ranging request message, may indicate, for example, that the mobile station 302 is attempting to handover to the target base station 306, or is attempting a network re-entry from idle mode to the target base station 306. Another bit may be set to indicate ranging request for a location update request, e.g., a mobile station action of an idle mode location update. Another bit of the ranging purpose indication may be set to indicate a ranging request for an emergency call setup between the mobile station 302 and the target base station 306. These are merely several examples of a ranging purpose indication field. The high priority handover for emergency calls may include emergency calls, calls from high priority user terminals such as calls from emergency management teams in disaster areas, for example. This may provide high priority handover and network access by such high priority user terminals, for example.

As an example, after the target base station 306 recognizes a purpose of the ranging request message 324 from the ranging purpose indication, the target base station 306 may invoke a priority sequencing, for example, of processing a ranging request for an emergency call at a higher priority than a handover ranging request, which may be processed at a higher priority than a location update in idle mode. Other types of purposes for ranging request messages may be processed at even a lower priority level, and a normal initial network entry ranging request message may be processed, for example, with a lowest priority level, according to an example embodiment. Thus, a processing priority and the priority of the resource allocation at the target base station 306 for the mobile station 302 may be based on the ranging purpose as indicated by the ranging purpose indication (RPI) field included in the ranging request message 324.

After processing the ranging request message 324, the target base station 306 may send a ranging response message (RNG-RSP) 326, which may include a challenge to verify identity to the mobile station 302. The ranging response message 326 may at least inform the mobile station 302 that the ranging request message 324 was received by the target base station 306, and thus, the mobile station 302 will not need to re-transmit the ranging request message 324. The ranging response message 326 may also include one or more adjustment parameters.

As a further aspect, a retransmission timer 328 for handover ranging may be set at the mobile station 302, and the retransmission timer value for handover ranging may be less than a retransmission timer value for non-handover ranging, for example. In an example embodiment, the information request, or the ranging request message 324 for handover may be retransmitted after a retransmission timer value has expired, which may be less than a retransmission timer value for non-handover ranging. In other words, the mobile station 302 may wait to receive a ranging response message for a predetermined waiting time before determining that it should re-transmit the ranging request message 324 to the target base station 306.

As an example, a default waiting time of 200 ms may be too long for some real-time applications which may, for example, require handover data transmission disruption time to be less than 50 ms, for example. Therefore, according to one example embodiment, the retransmission timer 328 of the mobile station 302 may be set based on an estimated processing time for the information request or the ranging request message 324 at the target base station 306 and any transmission delay that may be associated with the information request or the ranging request message 324 and the ranging response message 326. Further, if the information request or ranging request message may be recognized by the target base station 306 without need to process the whole message in order to accord a higher priority processing, then the processing time at the target base station 306 may be shortened.

For example, if a processing time at the target base station 306 may be determined to be 5 ms and a time division duplex (TDD) frame length is 5 ms, with a UL to DL ratio of 1:2, then the retransmission timer 328 at the mobile station 302 may be set to a value between 10 and 15 ms for handover ranging, which may be significantly less, for example, than a default retransmission timer value of 200 ms. The use of a lower retransmission timer value for handover ranging may shorten processing time and decrease ranging latency for handover processing, according to an example embodiment.

After the ranging response message 326 is received by the mobile station 302, encryption keys may be refreshed and normal transmission traffic may be restarted between the mobile station 302 and the target base station 306.

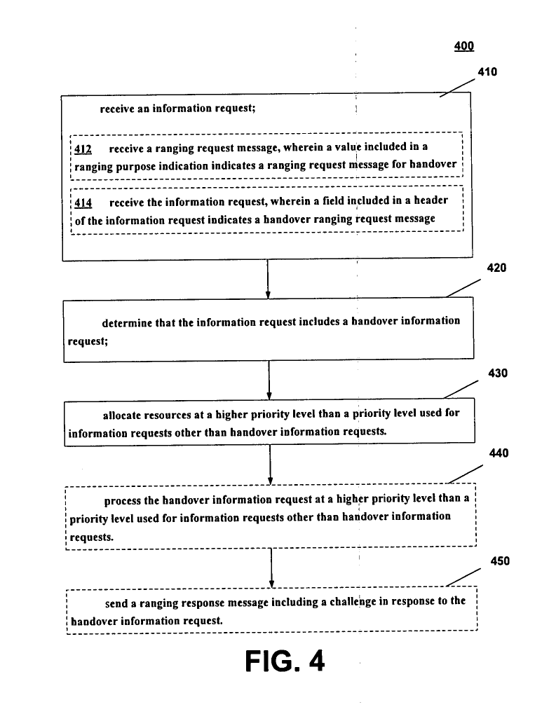

FIG. 4 is a flow chart 400 illustrating operation of handover of a mobile station according to another example embodiment. At 410, a wireless node, such as a target base station, may receive an information request from a mobile station, e.g., MS 110, to the target base station, e.g., BS2 106. The request may include a ranging request message, e.g., ranging request message 324, that may include a ranging purpose indication that indicates a handover request message. Alternatively, a field included in a header of the information request may indicate a handover ranging request message.

At 420, the wireless node may determine that the information request includes a handover information request. For example, the wireless node may determine that the information request includes a field included in a header of the information request that indicates a handover ranging request message, or it may determine that a value included in a ranging purpose indication indicates a handover information request message.

At 430, the wireless node may allocate resources at a higher priority level than a priority level used for information requests other than handover information requests. At 440, the wireless node may process the handover information request at a higher priority level than a priority level used for information requests other than handover information requests. At 450, the wireless node may send a ranging response message including a challenge in response to the handover information request. For example, the target base station 306 may send the ranging response message 326 to the mobile station 302 as discussed previously.

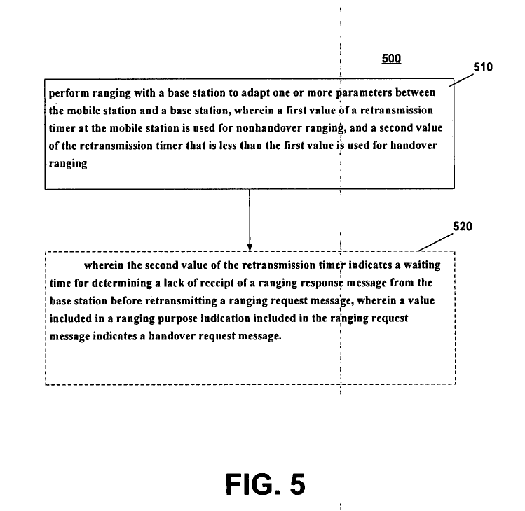

FIG. 5 is a flow chart 500 illustrating operation of a retransmission timer, e.g., retransmission timer 328, of a mobile station according to an example embodiment. At 510, an apparatus, e.g., the mobile station 302, may perform ranging with a base station, e.g., target base station 306, to adapt one or more parameters between the mobile station and the base station. A first value of a retransmission timer at the mobile station may be used for non-handover ranging, and a second value of the retransmission timer that is less than the first value is used for handover ranging. At 520, the second value of the retransmission timer may indicate a waiting time for determining a lack of receipt of a ranging response message, e.g., the ranging response message 326, from the base station before retransmitting a ranging request message, e.g., the ranging request message 324. In an example embodiment, a value may be included in a ranging purpose indication included in the ranging request message that may indicate a handover ranging request message. As discussed previously, the second value of the retransmission timer may, for example, be generated based on a time for transmission and a time of processing a message at the base station.

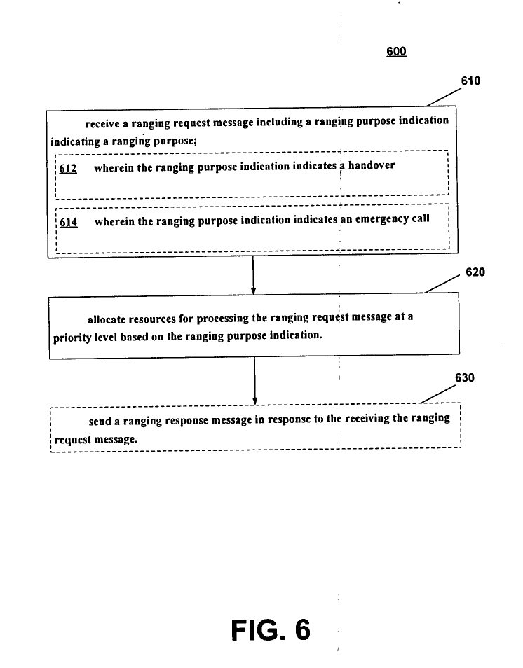

FIG. 6 is a flow chart 600 illustrating operation of ranging requests for a base station according to an example embodiment. At 610, a network node, e.g., target base station 306, may receive a ranging request message, e.g., the ranging request message 324, which may include a ranging purpose indication (RPI) indicating a ranging purpose. At 612, optionally, the ranging purpose indication may indicate a handover. At 614, optionally, the ranging purpose indication may indicate an emergency call.

At 620, the network node or target base station may allocate resources for processing the ranging request message at a priority level based on the ranging purpose indication. For example, if the ranging purpose indication indicates a handover, the ranging request message may be processed at a higher priority level than for other, lower priority, ranging purposes. As another example, a ranging request message including the ranging purpose indication indicating an emergency call may be processed at a higher priority level than other ranging request messages.

At 630, the network node may send a ranging response message, e.g., the ranging response message 326, to the mobile station 302, as discussed previously.

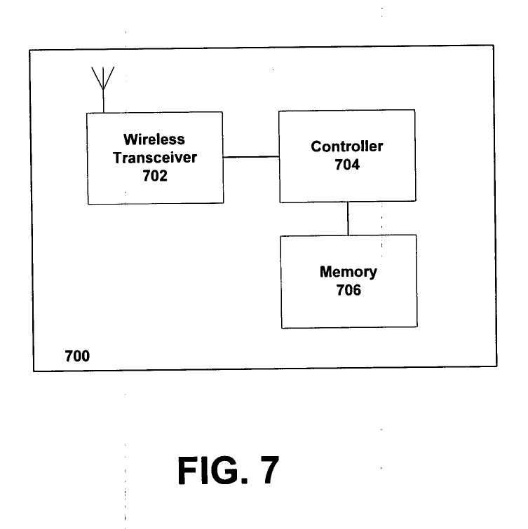

FIG. 7 is a block diagram illustrating an apparatus 700 that may be provided in a wireless station according to an example embodiment. The wireless station may include, for example, a wireless transceiver 702 to transmit and receive signals, a controller 704 to control operation of the station and execute instructions or software, and a memory 706 to store data and/or instructions. Controller 704 may be programmable, and capable of executing software or other instructions stored in memory or on other computer media to perform the various tasks and functions described above. In addition, a storage medium may be provided that includes stored instructions, when executed by a controller or processor that may result in the controller 704 performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
receiving an information request;
determining that the information request includes a handover information request; and
allocating resources at a higher priority level than a priority level used for information requests other than handover information requests.

2. The method of claim 1 wherein the receiving the information request comprises:
receiving a ranging request message, wherein a value included in a ranging purpose indication indicates a ranging request message for handover.

3. The method of claim 1 wherein:
the receiving the information request comprises receiving the information request, wherein a field included in a header of the information request indicates a handover ranging request message.

4. The method of claim 3 wherein:
the receiving the information request comprises receiving the information request, wherein the field included in the header includes a connection identifier indicating a handover ranging request message.

5. The method of claim 1 and further comprising:
processing the handover information request at a higher priority level than a priority level used for information requests other than handover information requests.

6. The method of claim 1 and further comprising:
sending a ranging response message including a challenge in response to the handover information request.

7. An apparatus provided in a mobile station for wireless communication, the apparatus comprising:
a controller;
a memory coupled to the controller; and
a wireless transceiver coupled to the controller; and
the apparatus is adapted to:
perform ranging with a base station to adapt one or more parameters between the mobile station and the base station, wherein
a first value of a retransmission timer at the mobile station is used for non-handover ranging, and a second value of the retransmission timer that is less than the first value is used for handover ranging.

8. The apparatus of claim 7 wherein the second value of the retransmission timer is generated based on a time for transmission and a time of processing a message at the base station.

9. The apparatus of claim 7 wherein the retransmission timer indicates a waiting time for determining a lack of receipt of a response from the base station before retransmitting a message to the base station.

10. The apparatus of claim 7 wherein the second value of the retransmission timer indicates a waiting time for determining a lack of receipt of a ranging response message from the base station before retransmitting a ranging request message indicating handover to the base station.

11. The apparatus of claim 7 wherein the second value of the retransmission timer indicates a waiting time for determining a lack of receipt of a ranging response message from the base station before retransmitting a ranging request message, wherein a value included in a ranging purpose indication included in the ranging request message indicates a handover ranging request message.

12. The apparatus of claim 7 wherein the second value of the retransmission timer indicates a waiting time for determining a lack of receipt of a ranging response message from the base station before retransmitting a ranging request message, wherein a field included in a header of the information request indicates a handover ranging request message.

13. The apparatus of claim 12 wherein the field included in the header includes a connection identifier indicating a handover ranging request message.

14. In a wireless network, a method comprising:
receiving a ranging request message including a ranging purpose indication indicating a ranging purpose; and
allocating resources for processing the ranging request message at a priority level based on the ranging purpose indication.

15. The method of claim 14 wherein the ranging purpose indication indicates a handover.

16. The method of claim 15 wherein the ranging request message including the ranging purpose indication indicating the handover is processed at a higher priority level than an other ranging request message including an other ranging purpose indication indicating a location update request.

17. The method of claim 14 wherein the ranging purpose indication indicates an emergency call or any call from a high priority user terminal.

18. The method of claim 17 wherein the ranging request message including the ranging purpose indication indicating the emergency call is processed at a higher priority level than other ranging request messages.

19. The method of claim 14 and further comprising processing the ranging request message at a priority level based on the ranging purpose indication.

20. The method of claim 14 and further comprising sending a ranging response message in response to the receiving the ranging request message.
